(19) United States
(12) Patent Application Publication
(10) Pub. No.: US 2016/0328654 A1
(43) Pub. Date: Nov. 10, 2016

(54) ANOMALY DETECTION FOR CONTEXT-DEPENDENT DATA

(71) Applicant: AGT International GmbH, Zurich (CH)

(72) Inventors: Alexander BAUER, Darmstadt (DE); Nico Heidtke, Darmstadt (DE); Maria Niessen, Darmstadt (DE); Andreas Merentitis, Darmstadt (DE)

(21) Appl. No.: 14/703,502

(22) Filed: May 4, 2015

(51) Int. Cl. G06N 5/04; G06N 99/00

(52) U.S. Cl. CPC G06N 5/048; G06N 99/005

(57) ABSTRACT

The present invention is a new method directed for detecting anomalies in monitored data having plurality of data-segments partitioned to context related initial-subspaces, the method comprising:
training an association-map between the initial-subspaces and feature-clusters of the plurality of data-segments, the training is responsive to a fit-criterion;
concatenating the initial-subspaces into cluster-subspaces, responsive to being associated to similar feature-clusters according to the association-map, to obtain a generalized-association-map;
pinpointing at least one anomaly of at least one new data-segment of the data, responsive to deviation-criterion for deviation of the new data-segment from its association to one of the feature-clusters, according to the generalized-association-map; and
triggering an automatic-act responsive to a trigger-criterion for the at least one anomaly.

### FIELD OF THE INVENTION

The present invention is related to clustering methods in general and in particular to anomaly detections within context-aware data.

### BACKGROUND

The present invention is in the field of solutions for internet of things (TOT) device providers, and for IoT analytic platform providers. The invention provides a generic capability to detect relevant events, reduce false-alerts and configure the detection parameters automatically based on training data only, taking away the tremendous costs of sensor-specific analytic configurations. The invention therefore enables market differentiation and increases productivity during deployment and maintenance of event detection systems.

Anomaly detection in observed data is performed by training or developing models of normality, where the anomaly detection is performed by observing for deviations of the tested data from the normality models. FIG. 1 depicts a prior art example of anomaly detection process configured for data with no significant context-dependent behavior. The process includes off-line and real-time modules, where the normality model is trained off-line and real-time measurements are examined in real-time for deviations from the normality model. Usually measurement data contains noise and the observed system might be better described through features that are calculated based on a measurement vector, namely a feature vector, accordingly an extraction step is often used to remove noise and extract relevant features.

In the case of vehicle traffic anomaly detection, normal traffic can change from minute to minute; accordingly, at least 2,900 models with 20 parameters have to be trained for such a process with no significant context-dependent behavior. The data collection process requires at least six weeks of collecting data samples for training the normality models. The training process, for training the 2,900 models, requires 5 M-Byte of parameter data per sensor to be kept in the memory in order to perform real-time anomaly detection. When introducing the above measurement data with context variables, the amount of the required training data and the required memory grow exponentially along with the resource consumption, like memory and processing time, for training the model and for the real-time detection. Further, this would require a large amount of training data to be collected in order to cover the context space with sufficient data points.

The obvious way to deal with context-aware detection is to carefully design a context partitioning for each anomaly detection use-case so that the models' count remains reasonable. To do that, knowledge about the observed system needs to be gained through domain expertise or by investigating a significant volume of annotated measurement data in order to identify which context parameters should be considered and at what granularity. For example, an insight must be contributed that Saturday and Sunday can be treated same for traffic incident detection. Of course this particular insight varies depending on where the sensor is deployed; for example different countries have different weekend days (e.g. Friday and Saturday in the Middle East). Another example is the influence of the weather which might depend on the type of road and therefore for some sensors the weather condition should be incorporated and for some it can be left out.

Context dependent anomaly detection has been solved in the prior art using either manual methods or adaptive context partitioning methods, as described in the following.

### Manual Context Partitioning

According to the manual context partitioning method, models are separated for the different contexts and any available context-agnostic models are used to model the measurements of a specific context. The context subspaces are defined manually for every use-case, for example incorporating the knowledge about weekend and weekday behavior, or by using very large volume of training data. Example for the manual context partitioning care are disclosed in Ihler et al., Adaptive event detection with time-varying Poisson processes, KDD '06 Proceedings of the 12^{th} ACM, pages 207-216, ACM New York, N.Y., USA ©2006 and in Cobb et al. U.S. Pat. No. 8,167,430.

### Conditional Probability Distribution Learning

According to the conditional probability distribution learning method the observed measurements are modelled as being generated by a conditional random distribution, with the context parameters as the condition space. Conditional probabilities can be learned through estimation of a total probability distribution, which is hardly possible, due to the required huge volume of training data, practically rarely available. An alternative method is Bayesian networks, as disclosed in Chapman et al. U.S. Pat. No. 8,682,571 and Downs et al. U.S. Pat. No. 7,899,611. The structure of such networks can be defined manually, or by learning methods. However these methods are only well-defined for discrete variables. As anomaly detection is usually performed on continuous measurement data, such methods cannot be directly applied.

### Function Estimation

According to the function estimation method the observed measurements are modelled as being generated by a deterministic function. For example, this can be done through decision tree learning as disclosed in Chapman et al. U.S. Pat. No. 8,682,571 and in Downs et al. U.S. Pat. No. 7,899,611, or through neural networks or look-up tables as disclosed in Burgess, Two Dimensional Time-Series for Anomaly Detection and Regulation in Adaptive Systems, lecture notes in computer science, volume 2506, 2002, pp 169-180.

Conversely, neither observed systems nor sensors have deterministic behavior; the measurements' noise and system's variational behavior are prominent in practical anomaly detection problems, and therefore function estimation methods cannot be learned nor represent such systems.

Clustering methods are widely used for unsupervised categorization of multi-dimensional data, for example to identify customer segments in customer relationship management data. Vector quantization is an application used for clustering, for example for lossy video and image compression, where the measurement data is represented by respective cluster centers. Gupta et al., Context-aware time series anomaly detection for complex systems, work shop notes—2^{nd} workshop on data mining for service and maintenance, Austin, Tex., May 4, 2013, pp. 14-22, discloses clustering context variables for context-aware anomaly detection. Gupta et al. map extracted context variables for further portioning of the data according to time series.

Accordingly, there is still an unanswered long felt need for a method and system that would efficiently use the context information of the measured data for accurate anomaly detection, and which will require smaller training groups and shorter training process.

### SUMMARY OF THE INVENTION

It is one object of the present invention to disclose a method directed for detecting anomalies in monitored data having plurality of data-segments partitioned to context related initial-subspaces, the method comprising:
training an association-map between the initial-subspaces and feature-clusters of the plurality of data-segments, the training is responsive to a fit-criterion;
concatenating the initial-subspaces into cluster-subspaces, responsive to being associated to similar the feature-clusters according to the association-map, to obtain a generalized-association-map;
pinpointing at least one anomaly of at least one new data-segment of the data, responsive to deviation-criterion for deviation of the new data-segment from its associated one of the feature-clusters, according to the generalized-association-map; and
triggering an automatic-act responsive to a trigger-criterion for the at least one anomaly.

It is another object of the present invention to disclose the method as defined above, wherein the data is continuous measurement-data collected from at least one sensor; and wherein the plurality of data-segments are feature-vectors extracted from plurality of sections of the data.

It is another object of the present invention to disclose the method as defined above, further comprising extracting the plurality of the feature-vectors from the plurality of sections.

It is another object of the present invention to disclose the method as defined above, wherein the extracting is performed by a method selected from the group consisting of: principal component analysis (PCA), independent component analysis, minimum noise fraction, random forest embedding, non-negative matrix factorization, and any combination thereof.

It is another object of the present invention to disclose the method as defined above, wherein each of the plurality of data-segments is labeled with at least one context-label; and wherein the method further comprising partitioning the plurality of data-segments to the context related initial-subspaces, responsive to a predetermined similarity in the at least one context-label.

It is another object of the present invention to disclose the method as defined above, further comprising selecting the at least one context-label from the group consisting of: days of the week, midweek- or weekend-days, time of the day, light- or dark-hours, holidays, public events, weather conditions, visibility, temperature, locations, measuring scenarios, population, and any combination thereof.

It is another object of the present invention to disclose the method as defined above, wherein the data is vehicle traffic measured data.

It is another object of the present invention to disclose the method as defined above, further comprising clustering the feature-clusters, using an unsupervised clustering-method.

It is another object of the present invention to disclose the method as defined above, wherein at least one of the following holds true:
the unsupervised clustering-method is selected from the group consisting of: K-means nearest neighbor, Density-based spatial clustering of applications with noise (DBSCAN), hierarchical clustering, Gaussian mixture, and any combination thereof;
the deviation-criterion and the pinpointing are determined by the unsupervised clustering method.

It is another object of the present invention to disclose the method as defined above, wherein at least one of the following holds true:
the clustering is incremental;
the training and the concatenating are incremental.

It is another object of the present invention to disclose the method as defined above, wherein the training further comprising defining at least one additional feature-cluster associated to the data-segments of at least one of the initial-subspaces, responsive to a failure of the one of the initial-subspaces to comply with the fit-criterion.

It is another object of the present invention to disclose the method as defined above, further comprising repeating the training and the concatenating, responsive to the defining of the at least one additional feature-cluster.

It is another object of the present invention to disclose the method as defined above, further comprising repeating the training and the concatenating, responsive to the defining of the at least one additional feature-cluster.

It is another object of the present invention to disclose the method as defined above, further comprising selecting the fit-criterion from the group consisting of: frequency threshold, average deviation threshold, statistical properties deviation threshold, dedicated matrices, Silhouette coefficients, and any combination thereof.

It is another object of the present invention to disclose the method as defined above, wherein the pinpointing and the triggering are in real-time.

It is another object of the present invention to disclose the method as defined above, wherein at least one of the following holds true:
the deviation is distance of the new data-segment from center from its the associated one of the feature-clusters;
the deviation is distance of the new data-segment from nearest data-segment in its the associated one of the feature-clusters.

It is another object of the present invention to disclose the method as defined above, further comprising selecting the trigger-criterion from the group consisting of:
a predetermined number of consecutive the at least one anomaly;
a predetermined number of the at least one anomaly within a selected group of the data-segments;
a magnitude-threshold for the deviation; and
any combination thereof.

It is another object of the present invention to disclose a computer system for detection of anomalies in monitored data having plurality of data-segments partitioned to context related initial-subspaces, the detection according to method steps comprising:
training an association-map between the initial-subspaces and feature-clusters of the plurality of data-segments, the training is responsive to a fit-criterion;
concatenating the initial-subspaces into cluster-subspaces, responsive to being associated to similar the feature-clusters according to the association-map, to obtain a generalized-association-map;
pinpointing at least one anomaly of at least one new data-segment of the data, responsive to deviation-criterion for deviation of the new data-segment from its associated one of the feature-clusters, according to the generalized-association-map; and triggering an automatic-act responsive to a trigger-criterion for the at least one anomaly;
   wherein the computer system comprising:
an interface component, configured to receive the data-segments;
a feature-extractor component, configured to extract the feature-clusters;
a context-identifier component, configured for partitioning of the plurality of data-segments to the context related initial-subspaces;
a mapping-machine component, configured to produce and update the generalized-association-map according to the steps of training and concatenating; and
an anomaly-detector, configured for the pinpointing of the at least one anomaly and for the triggering of the automatic act.

It is still an object of the present invention to a non-transitory computer readable medium (CRM) that, when loaded into a memory of a computing device and executed by at least one processor of the computing device, configured to execute the steps of a computer implemented method for detecting anomalies in monitored data having plurality of data-segments partitioned to context related initial-subspaces, the steps comprising:
training an association-map between the initial-subspaces and feature-clusters of the plurality of data-segments, the training is responsive to a fit-criterion;
concatenating the initial-subspaces into cluster-subspaces, responsive to being associated to similar the feature-clusters according to the association-map, to obtain a generalized-association-map;
pinpointing at least one anomaly of at least one new data-segment of the data, responsive to deviation-criterion for deviation of the new data-segment from its associated one of the feature-clusters, according to the generalized-association-map; and
triggering an automatic-act responsive to a trigger-criterion for the at least one anomaly.

It is lastly an object of the present invention to disclose the CRM as defined above, wherein at least one of the following holds true:
the CRM further configured to execute step of partitioning the plurality of data-segments to the context related initial-subspaces, responsive to a predetermined similarity in their the context;
the CRM further configured to execute step of clustering the feature-clusters, using an unsupervised clustering-method;
the data is continuous measurement-data collected from at least one sensor, and wherein the plurality of data-segments are feature-vectors extracted from plurality of sections of the data, and the CRM further configured for extracting the plurality of the feature-vectors from the plurality of sections;
the CRM further configured to execute step of defining at least one additional feature-cluster associated to the data-segments of at least one of the initial-subspaces, responsive to a failure of the one of the initial-subspaces to comply with the fit-criterion;
the steps of pinpointing and triggering are in real-time.

### BRIEF DESCRIPTION OF THE DRAWINGS

The subject matter disclosed may best be understood by reference to the following detailed description when read with the accompanying drawings in which:

FIG. 1 conceptually illustrates prior art anomaly detection process for context-independent data;

FIG. 2 conceptually illustrates prior art anomaly detection process for context-dependent data with corresponding learning-models;

FIG. 3 conceptually illustrates an embodiment of the method for detecting anomaly in context-aware data;

FIG. 4 conceptually illustrates an embodiment of a computer system configured for detecting anomaly in context-aware data;

FIGS. 5A, 5B and 5C conceptually illustrate mapping example of two dimensional feature-vector data;

FIGS. 6A, 6B and 6C conceptually illustrate anomaly detection performances of different partitioning methods.

For simplicity and clarity of illustration, elements shown are not necessarily drawn to scale, and the dimensions of some elements may be exaggerated relative to other elements. In addition, reference numerals may be repeated to indicate corresponding or analogous elements.

### DETAILED DESCRIPTION OF THE INVENTION

The following description is provided, alongside all chapters of the present invention, so as to enable any person skilled in the art to make use of the invention and sets forth the best modes contemplated by the inventor of carrying out this invention. Various modifications, however, are adapted to remain apparent to those skilled in the art, since the generic principles of the present invention have been defined specifically to provide a method and a system for detecting anomalies in monitored data having plurality of data-segments partitioned to initial-subspaces, according to context-labels of the data-segments.

The present invention provides a new method directed for detecting anomalies in monitored data having plurality of data-segments partitioned to context related initial-subspaces, the method comprising:
training an association-map between the initial-subspaces and feature-clusters of the plurality of data-segments, the training is responsive to a fit-criterion;
concatenating the initial-subspaces into cluster-subspaces, responsive to being associated to similar the feature-clusters according to the association-map, to obtain a generalized-association-map;
pinpointing at least one anomaly of at least one new data-segment of the data, responsive to deviation-criterion for deviation of the new data-segment from its associated one of the feature-clusters, according to the generalized-association-map; and
triggering an automatic-act responsive to a trigger-criterion for the at least one anomaly.

The present invention further provides a new computer system for detection of anomalies in monitored data having plurality of data-segments partitioned to context related initial-subspaces, the detection according to method steps comprising:
training an association-map between the initial-subspaces and feature-clusters of the plurality of data-segments, the training is responsive to a fit-criterion;
concatenating the initial-subspaces into cluster-subspaces, responsive to being associated to similar the feature-clusters according to the association-map, to obtain a generalized-association-map;
pinpointing at least one anomaly of at least one new data-segment of the data, responsive to deviation-criterion for deviation of the new data-segment from its associated one of the feature-clusters, according to the generalized-association-map; and
triggering an automatic-act responsive to a trigger-criterion for the at least one anomaly;
wherein the computer system comprising:
   an interface component, configured to receive the data-segments;
   a feature-extractor component, configured to extract the feature-clusters;
   a context-identifier component, configured for partitioning of the plurality of data-segments to the context related initial-subspaces;
   a mapping-machine component, configured to produce and update the generalized-association-map according to the steps of training and concatenating; and
   an anomaly-detector, configured for the pinpointing of the at least one anomaly and for the triggering of the automatic act.

The present invention further provides a new non-transitory computer readable medium (CRM) that, when loaded into a memory of a computing device and executed by at least one processor of the computing device, configured to execute the steps of a computer implemented method for detecting anomalies in monitored data having plurality of data-segments partitioned to context related initial-subspaces, the steps comprising:
training an association-map between the initial-subspaces and feature-clusters of the plurality of data-segments, the training is responsive to a fit-criterion;
concatenating the initial-subspaces into cluster-subspaces, responsive to being associated to similar the feature-clusters according to the association-map, to obtain a generalized-association-map;
pinpointing at least one anomaly of at least one new data-segment of the data, responsive to deviation-criterion for deviation of the new data-segment from its associated one of the feature-clusters, according to the generalized-association-map; and
triggering an automatic-act responsive to a trigger-criterion for the at least one anomaly.

Unless specifically stated otherwise, as apparent from the following discussions, throughout the specification discussions utilizing terms such as “processing”, “computing”, “storing”, “calculating”, “determining”, “evaluating”, “measuring”, “providing”, “transferring”, “outputting”, “inputting”, or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

The term “pinpoint” (or any form thereof), used herein is to be commonly understood as any of: find, locate, identify, indicate, determine, detect, notice, discover, recognize, diagnose, spot, investigate and trace.

The term “cluster” (or any form thereof), used herein refers to the task of grouping a set of objects (or as used herein a set of data-vectors) according to their features and/or characteristics in such a way that objects in the same group (called a cluster) are more similar in nature to each other than to those in other groups (clusters).

The term “context” (or any form thereof), used herein refers to the group of conditions that exist where and when the data was or is collected.

The term “anomaly” (or any form thereof), used herein is to be commonly understood as any of: irregularity, abnormality, difference, divergence and deviation.

According to various embodiments of the presented invention a system and a method are disclosed configured to find clusters in the measurements' data and establish a mapping between the measurement's context subspaces and the data's clusters in order to detect anomalies in the measured data.

Typically, anomaly detection is performed by learning models of normality and detecting deviations of new observations from the learned or trained models. The observed systems often behave differently depending on context like time of day, weather and public holidays. For example, for traffic anomaly detection, the traffic flow parameters may depend on: days of the week, mid-week or weekend days, time of the day, light or dark hours, holidays, special events, weather conditions, road condition, visibility, temperature, locations and measuring scenarios. These context parameters should to be incorporated into the anomaly detecting model in order to avoid false-alerts and to maintain detection sensitivity. It is known in the art that when introducing the additional context variables, the amount of training data and the required memory grow exponentially.

The common way to deal with models for context aware data is to carefully design context partitioning for each anomaly detection use-case, so that the models' count remains reasonable. To do that, knowledge about the observed system needs to be gained through domain expertise or by investigation of a significant volume of annotated measurement data, in order to identify which context parameters need to be considered and at what granularity. For example in vehicle traffic, knowledge must be available that Saturday and Sunday can be treated same for traffic incident detection, however, this particular insight may vary depending on where the sensor is deployed. Different countries have different weekend days (e.g. Friday and Saturday in the Middle East). Another example is the influence of the weather condition, which may depend on the type of ridden road, and therefore for the measurements of some sensors context regarding the weather condition should be incorporated and for some it can be left out. According to embodiments of the present invention, the disclosed system and method incorporate the context information with automatic optimization methods for the context's space without the need for human supervision or annotated training data.

### Common Anomaly Detection Process

Anomaly detection is performed by learning models of normality and detecting deviations of new observations from the learned models. Typically the data space is spanned from the measurements of at least one sensor providing a stream of data. The data is then collected at different- or constant-measurement intervals and stored in a database. The sensor's measurement can be a single value in time, represented by a single variable, or a set of values, represented as a measurement vector. The training data is then extracted from the database, at regular intervals (e.g. once a day), to learn the normality model, using statistical methods like minimum covariance determinant (MCD), regression methods, clustering methods; or classification methods like support vector machines (SVM) or one-class SVM. For real-time anomaly detection, new incoming sensors' measurements are tested against the learned model in order to calculate the magnitude of the deviation of the tested data from the model's mapped clusters.

According to some embodiments of the present invention, the magnitude of the deviation is further manipulated to define an anomaly Index. The anomaly index and the actual deviation from the normal distribution are further used to decide if an anomaly event is raised. The anomaly event is then presented to the user or used for triggering automatic actions. For example, if a traffic accident is detected, triggering an alert to the relevant authorities and redirecting the traffic.

The measurement data usually contains measuring noise. The observed system can be better described via selected features that are extracted from the measurement vector. According to some embodiments of the present invention, a step of feature extraction is used to remove noise and extract relevant features.

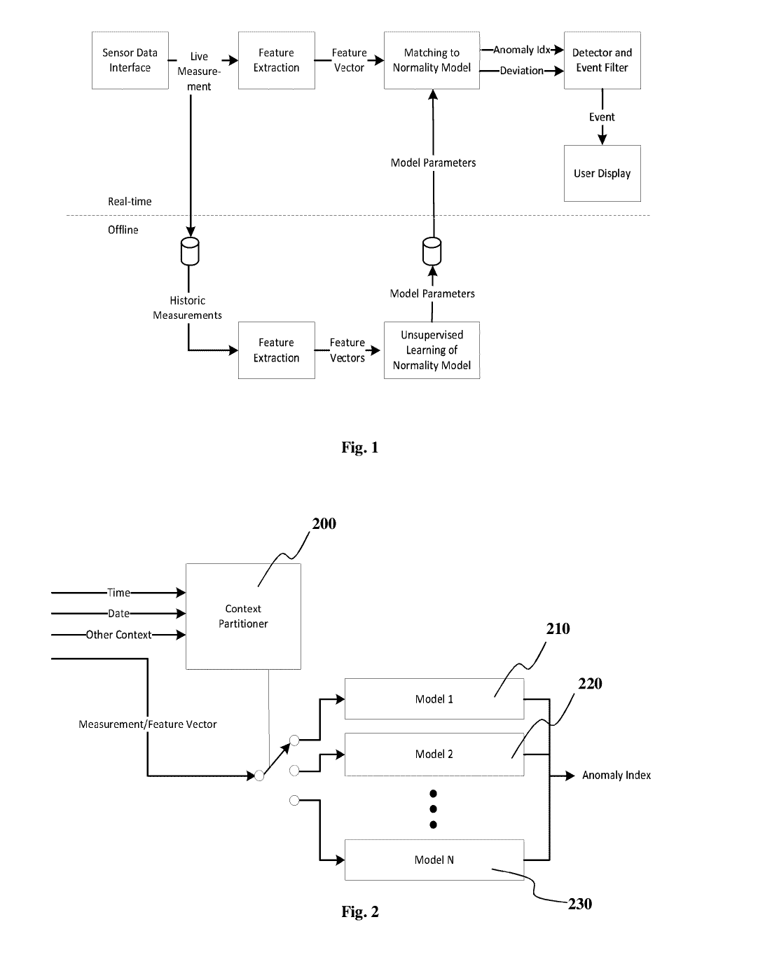

FIG. 1 illustrates a diagram for anomaly detection process, for monitoring systems without significant context-dependent behavior. In the diagram it is demonstrated that the sensor's data is processed and feature vectors are extracted for the model learning or training, during offline process. During the real-time examination of for deviation from the learned model, an anomaly index and the actual deviation are extracted for further decision whether an event should be determined and reported to the user.

### Context-Dependent Anomaly Detection

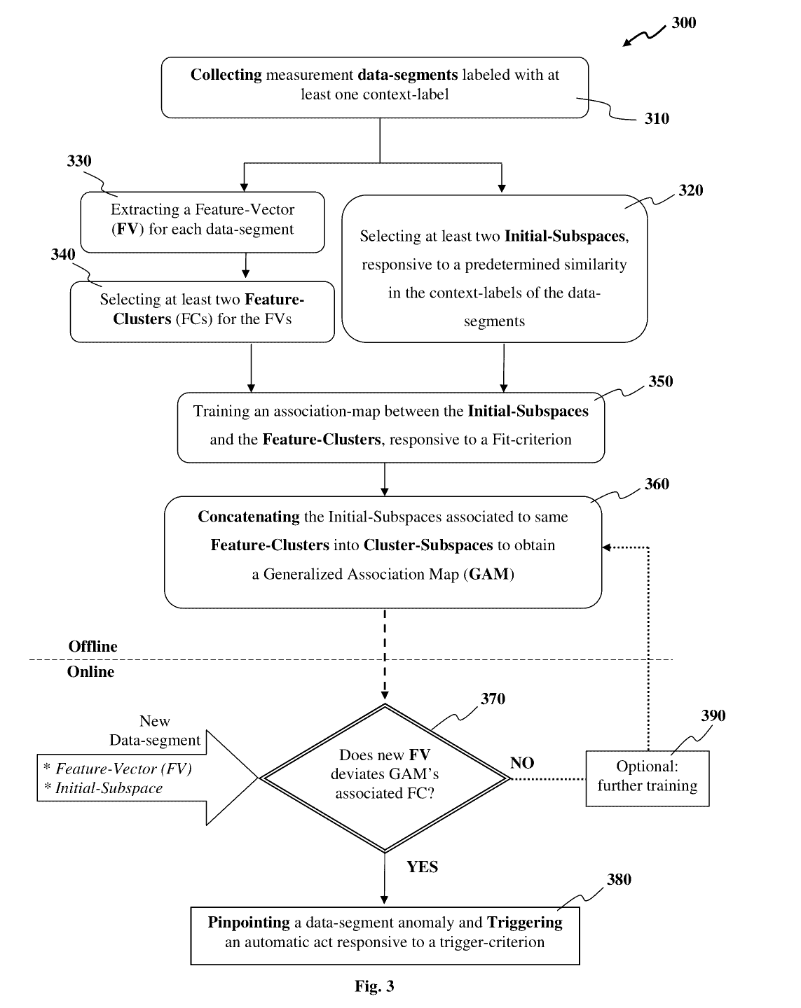

Context information often has strong influence on the behavior of an observed system; in traffic flow for example: time of day, weather, holidays, sport event and such. An anomaly detection system, as described in the above and in FIG. 1, is prone to false-alerts triggered by changes in measurements that are merely due to changes in the context. Such a system is prone to false-negatives, missing events which produce abnormal measurements only given a certain context configuration; for example, traffic jam during rush-hours on a weekend day. For such observed data having context information, anomaly detection systems incorporate context-dependent models, implemented via an extension of the method described in the above and in FIG. 1. Instead of learning a single model for all the data, individual models are learned for different context configurations. Such a system is disclosed in FIG. 2. A context partitioning module (200) divides the space of context parameters into several discrete subspaces and streams the data corresponding to each context partition into its own normality model instance (210-230).

Partitioning categorical information is achieved by assigning a context subspace for each category. Continuous information, like timestamps, has to be discretized using a uniform discretization. Multiple context variables can be combined through concatenation or generalization; for example, partitioning that takes into account day of week and time of day. The following context subspaces can be defined, as shown in Table 1, considering the day of the week and the time in minuets resolution.

TABLE 1
Context Extraction from timestamp

| Timestamp | Context labels |
|---|---|
| Jan. 6, 2014 03:27:12 PM | Monday_3_27 |
| Jan. 6, 2014 03:28:12 PM | Monday_3_28 |
| Jan. 5, 2014 03:28:12 PM | Sunday_3_28 |

FIG. 2 visualizes prior art methods to switch between the context's related models. The switching is performed both during real-time detection and for the offline model training.

Using this approach, the context dependency can be modelled very accurately, however there are limitations:
sufficient training samples should be provided for each context configuration; and
the memory consumption increases linearly, with the number of the models to be trained.

The obvious way to deal with the above mentioned limitations is to carefully design the partitioning for each anomaly detection use-case. To do that, knowledge about the observed system needs to be gained through domain experts or by investigating a significant volume of annotated measurement data, in order to identify which context parameters should to be considered and at what granularity.

### Application for Traffic Anomaly Detection

The general approach described above can be applied, according to a non-limiting example, to traffic anomaly detection. According to some embodiments of the present invention, the measuring sensors may include: license plate recognition (LPR) sensors, video analytics and magnetic loop detectors. The characteristic features extracted from the raw data can include: average speed, total vehicle volume, speed difference between the different lanes and vehicle volume difference between the different lanes. The data, according to this example, is acquired and stored once a minute. Weekend and weekdays have to be treated separately, and different times of day are partitioned according to one minute intervals.

According to some embodiments of the present invention, a minimum covariance determinant method (MCD) is used to model the distribution of the data inside a context subspace.

According to some embodiments of the present invention, in order to reduce false anomaly-alerts, a persistence check is applied to make sure that the abnormal state persists at least for two minutes until an anomaly-detection is triggered.

According to some embodiments of the present invention, the deviation vector, which is the difference of a measurement from the mean vector of its corresponding model, can be used to distinguish different types of traffic anomalies, for example traffic jam and partial road-blocks, by applying simple rules on the deviation vector; like for example speed difference thresholds.

### Adaptive Partitioning for Context-Dependent Anomaly Detection

In order to overcome the above mentioned limitations of static or hand-crafted context partitioning, the present invention discloses an adaptive method to determine efficient context-aware partitions which incorporates the features of the actual measurement data. According to a preferred embodiment, the method spans a map between clusters of the measurement's data and initial-subspaces of the initial context-aware partitions; the initial-subspaces are based on the context-aware labels solely.

Further mapping is conducted by observing common distributions or clusters in the measurement's data and concatenating the initial-subspaces that share similar data distributions or similar clusters into common clusters-subspaces. In so doing, the initial context-aware subspaces are concatenated into fewer cluster-subspaces. Accordingly the amount of data available for the models' training is increased and the required memory and number of models are reduced, without the use of any manual optimization or configuration.

According to one embodiment of the invention the mapping method is implemented as follows:
1. Creating initial partitions by concatenation of predetermined similar context variables (e.g. day and minute: Monday_3_27) of the data-segments which can be represented by feature vectors, thereby creating initial-subspaces;
2. Clustering the feature vectors (of the data-segments) using an unsupervised clustering method (e.g. K-Means) to feature-clusters; and
3. For each of the initial subspaces, decide responsive to a fit-criteria whether:
   a. the initial-subspace is mapped to one of the feature-clusters that is identified by a cluster id, if it is well represented by that cluster; or
   b. the initial-subspace is preserved if its measurement data cannot be represented properly by any of the feature-clusters.

According to another embodiment of the invention, the mapping is implemented as follows:
1. Collecting plurality of data-segments (e.g., one minute data intervals), each having at least one context-label;
2. Extracting a concise feature-vector for each of the data-segments, using at least one of: principle component analysis (PCA), independent component analysis, minimum noise fraction, random forest embedding, non-negative matrix factorization and any combination thereof;
3. Gathering the extracted feature-vectors into initial-subspaces, responsive to predetermined similarity in their related context-labels (e.g. day and minute: Monday_3_27);
4. Clustering the feature-vectors into feature-clusters, using at least one unsupervised clustering method selected of: K-means nearest neighbor, density-based spatial clustering of applications with noise (DBSCAN), hierarchical clustering. Gaussian mixture and any combination thereof;
5. Training an association-map between the initial-subspaces and the feature-clusters, according to a predetermined fit criteria by:
   a. linking an initial-subspace to at least one of the feature-clusters, responsive to compliance with the fit criteria; or,
   b. if an initial-subspace is not linked to any of the existing feature-clusters,
      i. defining the initial-subspace as a new feature-cluster; or,
      ii. re-gathering the initial-subspaces, as in (1); or,
      iii. re-clustering the feature-clusters, as in (4);
6. Concatenating the initial-subspaces into feature-subspaces, responsive to being associated to similar feature-clusters, thereby obtaining a generalized-association-map;
7. Detecting an anomaly of a new feature-vector (of a new data-segment), responsive to deviating from the generalized-association-map;
8. If no anomaly is detected for the new feature-vector, associating the new feature-vector with at least one of the feature-clusters; thereby further training the generalized-association-map.

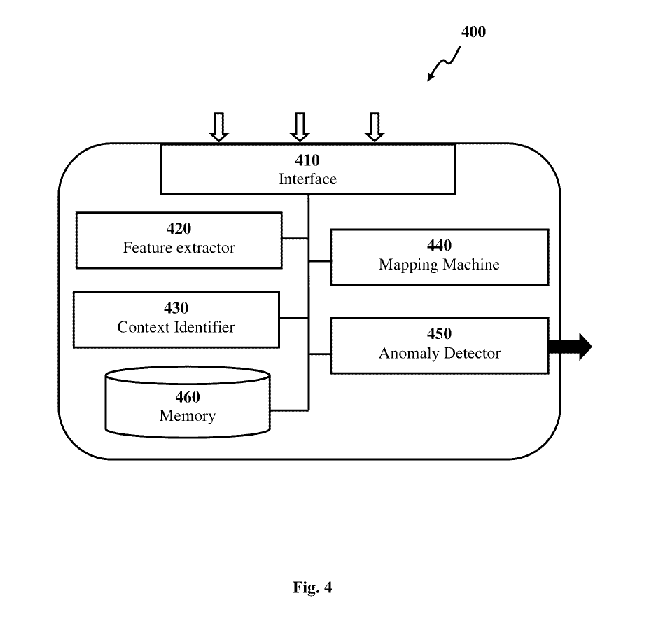

Reference is now made to FIG. 3 conceptually illustrating another embodiment for the adaptive context-dependent anomaly detection method (300). According to this embodiment training is conducted offline in steps 310-360, and the detecting is conducted in real-time as in steps 370-390. As shown:
step 310 demonstrates collecting measurement data-segments labeled with at least one context-label;
step 320 demonstrates selecting initial-subspaces, responsive to a predetermined similarity in the context-labels of the data-segments;
step 330 demonstrates extracting a concise feature-vector (FV) for each of the data-segments;
step 340 demonstrates selecting feature-clusters (FCs) for the extracted feature vectors;
step 350 demonstrates training an association-map between the initial-subspaces and the selected feature-clusters, responsive to a predetermined fit-criterion;
step 360 demonstrates concatenating the initial-subspaces associated to same feature-clusters into cluster-subspaces to obtain a Generalized Association Map (GAM);
step 370 demonstrates examining whether the feature-vector of a new data-segments deviates from its associated feature-cluster, responsive to a deviation criterion, where the associated feature vector is selected according to the data-segment's context-labels and the GAM;
step 380 demonstrates pinpointing a data-segment anomaly and Triggering an automatic act responsive to a trigger-criterion; and
step 390 demonstrates an optional step of using a normal new data-segment for further real-time training of the GAM.

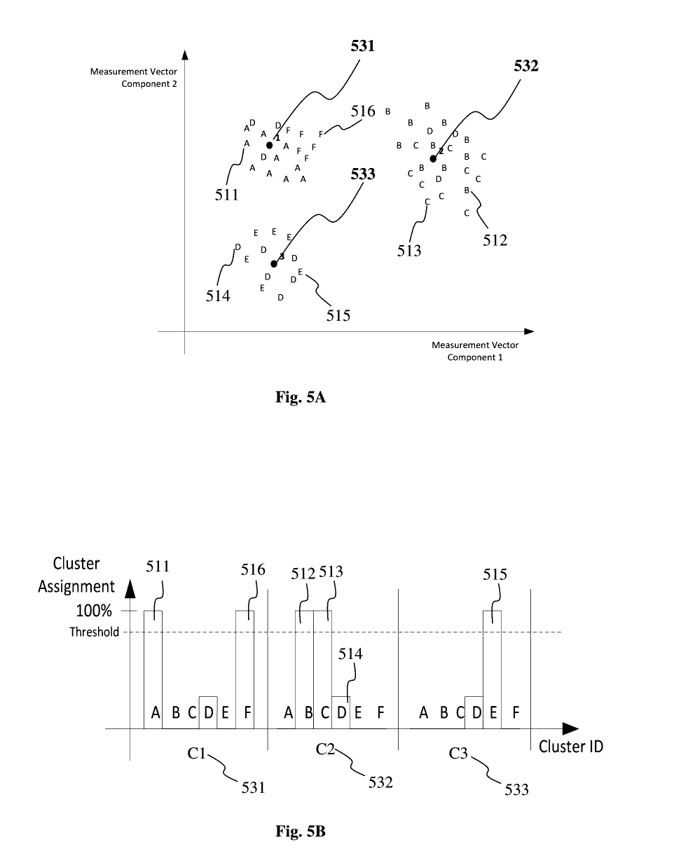

Reference is now made to FIG. 4 conceptually illustrating an embodiment for the computer system configured for adaptive context-dependent anomaly detection. The computer system (400) comprising:
an interface component (410), configured to receive the data and/or the data-segments;
a feature-extractor component (420), configured to extract a concise feature-clusters for each of the data-segments;
a context-identifier component (430), configured to identify the initial-subspaces, responsive to a predetermined similarity in the context-labels of the data-segments;
a mapping-machine component (440), configured to produce and update the generalized-association-map mentioned above; and
an anomaly-detector (450), configured to pinpoint the anomalies in the monitored data and trigger an automatic act responsive to a trigger-criterion for the pinpointed anomalies.

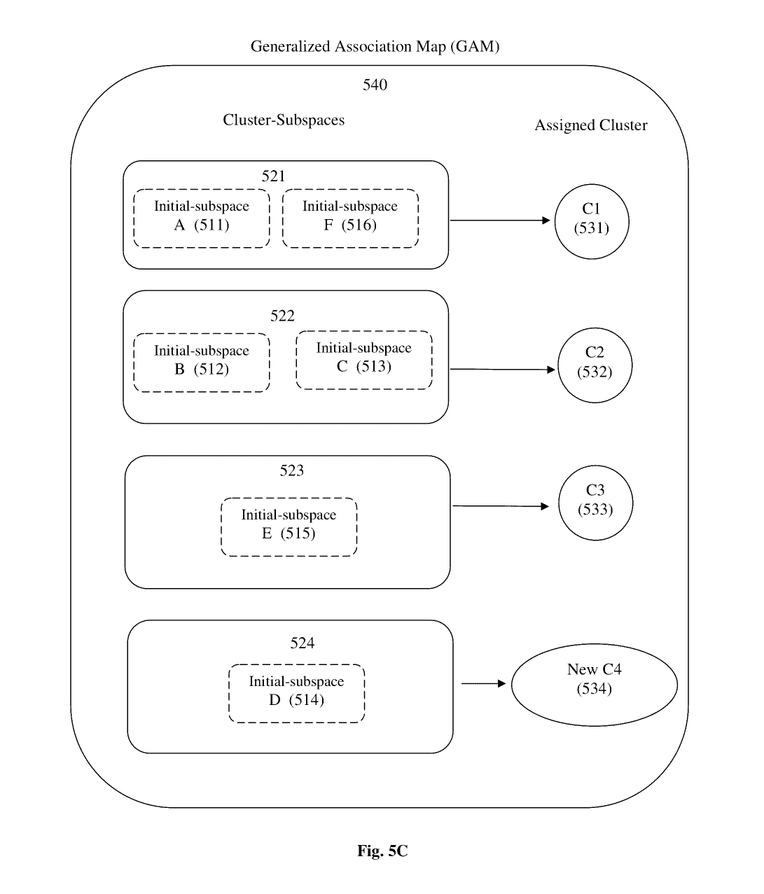

Reference is now made to figures FIGS. 5A, 5B and 5C conceptually illustrating an example of two dimensional feature-vectors (v1,v2) partitioned into six context-label subspaces—labels A-F (initial-subspaces, 511-516) distributed into three feature-clusters (531-533) having Cluster IDs 1-3, and further demonstrating the distribution of cluster assignments for the different context-label subspaces (cluster-subspaces, 521-524).

Specifically, FIG. 5A demonstrates an example of two-dimensional measurement data represented by a two-dimensional feature-vector (v1,v2). The letters A-F represent the context partitioning into six initial-subspaces (511-516) of the measurement data. The unsupervised clustering method applied for this example is K-means nearest neighbor, which identified three feature-clusters in the measured data (531-533), identified as IDs 1, 2 and 3. Using a goodness of fit-criteria, as will be described in the following, context subspaces (the initial-subspaces) labeled A to F are linked to the feature-clusters (531-533) or kept as individual cluster-subspaces (524) mapped to a new feature cluster (534).

FIG. 5B demonstrates an example of a basic goodness of fit-criteria configured to determine whether an initial-subspace is to be assigned to a specific feature-cluster. For each initial-subspace, the relative frequency of attendance to a specific feature-cluster is determined. If the frequency of attendance in the specific feature-cluster exceeds a predetermined threshold, for example a non-limiting example 90%, the initial-subspace is linked to the examined feature-cluster.

FIG. 5C demonstrates the step of concatenating the initial-subspaces (511-516) associated to same feature-clusters (531-533) into cluster-subspaces (521-523) in order to obtain a Generalized Association Map (GAM, 540). FIG. 5C further demonstrates the case of the initial-subspace D (514), which could not be associated to any of the data's feature-clusters (531-533) and therefore a new cluster-subspace (524) is defined which is associated to a newly defined feature-cluster (534).

According to another embodiment of the invention, the case of the initial-subspace D (514), which could not be associated to any of the data's clusters (531-533) may be considered as having a redundant context-label, which should be ignored, and the data-segments or feature-vectors of that initial-subspace (514) should spread and related to any of the other initial-subspaces (511-513,515-516).

According to an embodiment of the invention, the fit-criterion is a predetermined threshold for the difference between the average deviation of the feature-vectors of an initial-subspace and the center of the examined feature-cluster.

According to another embodiment of the invention, the fit-criterion is a predetermined threshold for the difference between the statistical properties (e.g. standard deviation, covariance matrix) of all related feature-vectors assigned to a specific feature-cluster and the statistical properties of the feature-vectors of the particular examined initial-subspace.

According to another embodiment of the invention, the fit-criterion is chosen as dedicated metrics. The dedicated matrices can be derived purely from empiric methods (e.g., elbow method) that typically require human interpretation and can be sometimes ambiguous, fully automated ones (for example approaches based on Bayesian Information Criterion for clustering) which typically require a lot of data, as well as methods that fall between the two extremes, such as Silhouette coefficients and diagrams. An example for dedicated cluster goodness of fit-criteria metrics is the case of Silhouette coefficients, although other metrics may also be employed.

Specifically, Silhouette coefficients measure the cohesion of each (potentially new) point of a cluster to the others, as well as the separation from the most nearby cluster. When used to examine if a new point “p” should be assigned to a particular cluster “C” the method is as follows:
For each new point “p”, calculate initially the average distance between “p” and all other points in the considered cluster “C” (this is a Measure of Cohesion, called MC in the sequel).
Then calculate the average distance between “p” and all points in the nearest cluster (this is a Measure of Separation from the closest other cluster, called MS in the sequel). If the nearest cluster is not known, the distance can be calculated to each nearby cluster, selecting the smallest one as MS.
The Silhouette coefficient for “p”, if assigned to the considered cluster “C”, is defined as the difference between MS and MC divided by the greater of the two (max(MC,MS)). Intuitively, we are trying to measure the space between clusters.
If cluster cohesion is good (MC is small) and cluster separation is good (MS is large), the numerator will be large. Therefore, a Silhouette coefficient close to 1 implies the datum should be assigned to the cluster C, while a Silhouette close to −1 implies the datum should be assigned to a different cluster.

### Examples

### Performance Evaluation on Simulated Traffic Datasets

### Data for Comparison

To demonstrate the advantages of the embodiments of the present invention, experimental detecting results on simulated datasets are presented. Each dataset simulates a daily recurring process as is common in traffic monitoring, with several steady state switches during the day, e.g. low traffic at nighttime, and morning/evening rush-hours. Measurements were taken at a one minute intervals, with four feature measurement dimensions (four different sensors) and at different daily patterns including weekend and weekdays. White Gaussian noise of −20 dB relative to measurement level was added to simulate sensors' noise. Eighty anomalies each of twenty minutes duration were introduced, by adding a constant vector to the normal feature vector. The magnitude of the anomaly vector is 12 dB above the additive noise level.

A comparison is provided between: model computation time, size of the trained model (measured in memory Bytes) and detection accuracy (demonstrated by F-Measure) of three prior art hand-crafted partitioning configurations versus the currently disclosed adaptive partitioning method.

The three prior art demonstrated methods are:
partitioning data of 1 minute (min) intervals according to time of the day (TOD); noted as “TOD (1 min)”;
partitioning data of 1 min intervals according to time of the day (TOD) and according to whether it is a week day (WD) or a weekend day (WE); noted as “TOD (1 min) WE/WD”; and
partitioning data of 5 min intervals according to time of the day (TOD) and according to whether it is a week day (WD) or a weekend day (WE); noted as “TOD (5 min) WE/WD”.

The currently disclosed adaptive partitioning method is demonstrated using 1 min data-segments, with the context labels being the time of the day (TOD) and where the clustering method is K-mean, with K=150 clusters; noted as “Auto (150 Cluster)” or as “Adaptive (150 Clusters)”. The anomalies were detected for all four methods using the MCD anomaly detection method.

### Results of Comparison

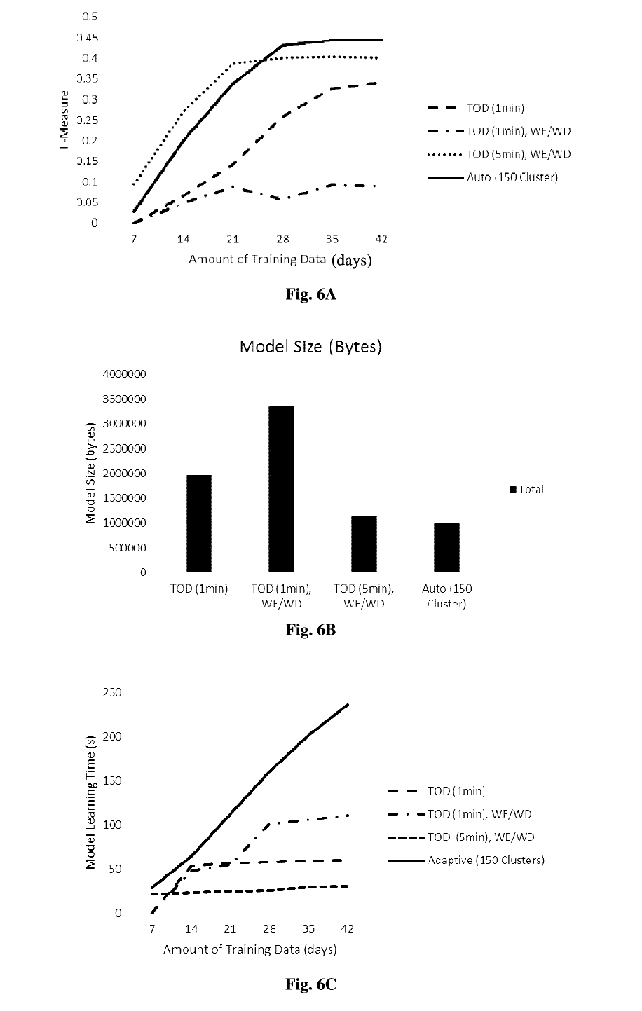

FIGS. 6A and 6B present the comparison results and demonstrate that the currently disclosed adaptive partitioning method outperforms the best prior art manual partitioning method, in terms of F-Measure as in FIG. 6A and in terms of model size as in FIG. 6B, when a training database of more than 21 days is available, without the need for any specific knowledge about the daily pattern or any manual data investigation. The results further demonstrates that even with lower amount of training data, the currently disclosed adaptive partitioning method provides similar performances similar to the best prior art manual partitioning method and outperforms the other two methods of the manually selected partitions.

FIG. 6C presents the required processing time for each of the tested methods, and demonstrates that the required processing time for the currently presented method is higher than of the best manual partitioning method since the features' clustering method introduces additional processing time. The processing time wows roughly linearly with the amount of training data. However, since the training has to be performed only at infrequent intervals (e.g. once a day, once a week), the processing time has only minor impact on the practical value of the method.

### Conclusions—Considerations for the Clustering Method

The number of clusters influences the resolution of the normality model and the number of cluster-subspaces created. It can be therefore be used to control the maximum amount of memory used. To further automate the selection of the number of clusters, clustering methods that automatically decide on the number of clusters based on the data can be applied, for example BSCAN or DBSCAN.

Possible Extension: Multi-Pass Clustering for Dealing with Multimodal Data

The approach described above is well suited for data that can be modeled properly using a unimodal distribution. For measurement data that has multiple modes, the data in the same context subspace will very likely be assigned to multiple clusters, and grouping of subspaces will not be possible efficiently. In this case we propose to do a second pass of clustering on the cluster assignment distribution of each subspace (the distribution is shown in Error! Reference source not found. 5A and 5B). This way, context initial-subspaces like the one labeled with the letter D which are significantly assigned to multiple cluster centers and therefore are not grouped according to the goodness of fit criteria, can be grouped based on a goodness of fit on the second pass clustering.

Envisioned Embodiments include:
Stand-alone system that relearns models at regular intervals, performs model matching in real-time;
Integration into a distributed computing environment using Lambda architecture for batch and real-time processing.
Distribution of model learning and real-time execution, for example using edge computing. The real-time matching executed at the edge would benefit of the reduced memory consumption of the model. The model learning is performed on the backend where enough processing power is available.

Further applications and industries that would require anomaly detection and can benefit from context-aware variables may include, but are not limited to: power plants, power grids, manufacturing plants, monitoring electricity consumption, monitoring water consumption, security methods, online/cloud security methods, demand of different commercial goods (books, movies, furniture) and more. The form of the context-aware variables can be: time series, structured-text, semi structured-text and unstructured-text. The present invention further lowers the hardware requirements to run anomaly detection on an edge device, which usually has low memory capacity.

It is understood that various other modifications will be readily apparent to those skilled in the art without departing from the scope and spirit of the invention. Accordingly, it is not intended that the scope of the claims appended hereto be limited to the description set forth herein, but rather that the claims be construed as encompassing all the features of the patentable novelty that reside in the present invention, including all features that would be treated as equivalents thereof by those skilled in the art to which this invention pertains.

We claim:

1. A method directed for detecting anomalies in monitored data having plurality of data-segments partitioned to context related initial-subspaces, said method comprising:
training an association-map between said initial-subspaces and feature-clusters of said plurality of data-segments, said training is responsive to a fit-criterion;
concatenating said initial-subspaces into cluster-subspaces, responsive to being associated to similar said feature-clusters according to said association-map, to obtain a generalized-association-map;
pinpointing at least one anomaly of at least one new data-segment of said data, responsive to deviation-criterion for deviation of said new data-segment from its associated one of said feature-clusters, according to said generalized-association-map; and
triggering an automatic-act responsive to a trigger-criterion for said at least one anomaly.

2. The method according to claim 1, wherein said data is continuous measurement-data collected from at least one sensor; and wherein said plurality of data-segments are feature-vectors extracted from plurality of sections of said data.

3. The method according to claim 2, further comprising extracting said plurality of said feature-vectors from said plurality of sections.

4. The method according to claim 3, wherein said extracting is performed by a method selected from the group consisting of: principal component analysis (PCA), independent component analysis, minimum noise fraction, random forest embedding, non-negative matrix factorization, and any combination thereof.

5. The method according to claim 1, wherein each of said plurality of data-segments is labeled with at least one context-label; and wherein said method further comprising partitioning said plurality of data-segments to said context related initial-subspaces, responsive to a predetermined similarity in their said at least one context-label.

6. The method according to claim 5, further comprising selecting said at least one context-label from the group consisting of: days of the week, midweek- or weekend-days, time of the day, light- or dark-hours, holidays, public events, weather conditions, visibility, temperature, locations, measuring scenarios, population, and any combination thereof.

7. The method according to claims 2 and 5, wherein said data is vehicle traffic measured data.

8. The method according to claim 1 or 2, further comprising clustering said feature-clusters, using an unsupervised clustering-method.

9. The method according to claim 8, wherein at least one of the following holds true:
said unsupervised clustering-method is selected from the group consisting of: K-means nearest neighbor, Density-based spatial clustering of applications with noise (DBSCAN), hierarchical clustering, Gaussian mixture and any combination thereof;
said deviation-criterion and said pinpointing are determined by said unsupervised clustering-method.

10. The method according to claim 8, wherein at least one of the following holds true:
said clustering is incremental;
said training and said concatenating are incremental.

11. The method according to claim 1 or 10, wherein said training further comprising defining at least one additional feature-cluster associated to said data-segments of at least one of said initial-subspaces, responsive to a failure of said one of said initial-subspaces to comply with said fit-criterion.

12. The method according to claim 11, further comprising repeating said training and said concatenating, responsive to said defining of said at least one additional feature-cluster.

13. The method according to claims 5 and 8, further comprising repeating said partitioning with a different said predetermined similarity and/or repeating said clustering with a different number of clusters, responsive to a failure of at least one of said initial-subspaces to comply with said fit-criterion.

14. The method according to claim 1, further comprising selecting said fit-criterion from the group consisting of: frequency threshold, average deviation threshold, statistical properties deviation threshold, dedicated matrices, Silhouette coefficients, and any combination thereof.

15. The method according to claim 1, wherein said pinpointing and said triggering are in real-time.

16. The method according to claim 1, wherein at least one of the following holds true:
said deviation is distance of said new data-segment from center from its said associated one of said feature-clusters;
said deviation is distance of said new data-segment from nearest data-segment in its said associated one of said feature-clusters.

17. The method according to claim 1, further comprising selecting said trigger-criterion from the group consisting of:
a predetermined number of consecutive said at least one anomaly;
a predetermined number of said at least one anomaly within a selected group of said data-segments;
a magnitude-threshold for said deviation; and
any combination thereof.

18. A computer system for detection of anomalies in monitored data having plurality of data-segments partitioned to context related initial-subspaces, said detection according to method steps comprising:
training an association-map between said initial-subspaces and feature-clusters of said plurality of data-segments, said training is responsive to a fit-criterion;
concatenating said initial-subspaces into cluster-subspaces, responsive to being associated to similar said feature-clusters according to said association-map, to obtain a generalized-association-map;
pinpointing at least one anomaly of at least one new data-segment of said data, responsive to deviation-criterion for deviation of said new data-segment from its associated one of said feature-clusters, according to said generalized-association-map; and
triggering an automatic-act responsive to a trigger-criterion for said at least one anomaly;
wherein said computer system comprising:
an interface component, configured to receive said data-segments;
a feature-extractor component, configured to extract said feature-clusters;
a context-identifier component, configured for partitioning of said plurality of data-segments to said context related initial-subspaces;
a mapping-machine component, configured to produce and update said generalized-association-map according to said steps of training and concatenating; and
an anomaly-detector, configured for said pinpointing of said at least one anomaly and for said triggering of said automatic act.

19. A non-transitory computer readable medium (CRM) that, when loaded into a memory of a computing device and executed by at least one processor of said computing device, configured to execute the steps of a computer implemented method for detecting anomalies in monitored data having plurality of data-segments partitioned to context related initial-subspaces, said steps comprising:
training an association-map between said initial-subspaces and feature-clusters of said plurality of data-segments, said training is responsive to a fit-criterion;
concatenating said initial-subspaces into cluster-subspaces, responsive to being associated to similar said feature-clusters according to said association-map, to obtain a generalized-association-map;
pinpointing at least one anomaly of at least one new data-segment of said data, responsive to deviation-criterion for deviation of said new data-segment from its associated one of said feature-clusters, according to said generalized-association-map; and
triggering an automatic-act responsive to a trigger-criterion for said at least one anomaly.

20. The CRM according to claim 19, wherein at least one of the following holds true:
said CRM further configured to execute step of partitioning said plurality of data-segments to said context related initial-subspaces, responsive to a predetermined similarity in their said context;
said CRM further configured to execute step of clustering said feature-clusters, using an unsupervised clustering-method;
said data is continuous measurement-data collected from at least one sensor, and wherein said plurality of data-segments are feature-vectors extracted from plurality of sections of said data, and said CRM further configured for extracting said plurality of said feature-vectors from said plurality of sections;
said CRM further configured to execute step of defining at least one additional feature-cluster associated to said data-segments of at least one of said initial-subspaces, responsive to a failure of said one of said initial-subspaces to comply with said fit-criterion;
said steps of pinpointing and triggering are in real-time.
